(19) United States
(12) Patent Application Publication
(10) Pub. No.: US 2025/0165449 A1
(43) Pub. Date: May 22, 2025

(54) DATA PROCESSING METHOD, FORWARDING CHIP, STORAGE MEDIUM AND PROGRAM PRODUCT

(71) Applicant: ZTE CORPORATION, Shenzhen (CN)

(72) Inventors: Xia WU, Shenzhen (CN); Meiqin WANG, Shenzhen (CN); Yunchuan XU, Shenzhen (CN); Jiamin CUI, Shenzhen (CN); Muzhou LI, Shenzhen (CN); Yanhong FAN, Shenzhen (CN); Lixuan WU, Shenzhen (CN)

(21) Appl. No.: 18/839,876

(22) PCT Filed: Jan. 9, 2023
(86) PCT No.: PCT/CN2023/071347

§ 371 Date: Aug. 20, 2024

(30) Foreign Application Priority Data
Feb. 21, 2022 (CN) 202210158035.2

(51) Int. Cl. G06F 16/22; G06F 16/27; G06F 17/16

(52) U.S. Cl. CPC G06F 16/2255; G06F 16/273; G06F 17/16

(57) ABSTRACT

Disclosed are a data processing method, a forwarding chip, a non-transitory computer-readable storage medium and a program product. The data processing method may include: acquiring an input parameter used for generating an index value to be filled in a hash table; performing data replication processing on the input parameter to obtain a plurality of input parameters; performing corresponding data mapping processing on each of the plurality of input parameters to obtain a plurality of output variables; and performing data integration processing on the plurality of output variables to obtain the index value.

### CROSS-REFERENCE TO RELATED APPLICATION

This application is a national stage filing under 35 U.S.C. § 371 of international application number PCT/CN2023/071347, filed Jan. 9, 2023, which claims priority to Chinese patent application No. 202210158035.2, filed Feb. 21, 2022. The contents of these applications are incorporated herein by reference in their entirety.

### TECHNICAL FIELD

The present disclosure relates to the technical field of data processing, and in particular, to a data processing method, a forwarding chip, a storage medium, and a program product.

### BACKGROUND

A lookup table in a forwarding chip is usually implemented with a Hash table structure, which uses a key word as an input value to a Hash function to obtain an index value of the Hash table. In related technologies, a Cyclical Redundancy Check (CRC) algorithm is often used as the Hash function in the forwarding chip. However, the use of the CRC algorithm gives rise to some problems. For example, bits in the index value output by the CRC algorithm are obtained from a simple exclusive OR operation on some bits in the keyword. Therefore, the bits in the index value of this algorithm have a high degree of correlation, seriously affecting the stability of the optimal fill rate of the Hash table.

### SUMMARY

The following is a summary of the subject matter set forth in this description. This summary is not intended to limit the scope of the claims.

Embodiments of the present disclosure provide a data processing method, a forwarding chip, a storage medium, and a program product.

In accordance with a first aspect of the present disclosure, an embodiment provides a data processing method, including: acquiring an input parameter, where the input parameter is used for generating an index value to be filled in a hash table; performing data replication processing on the input parameter to obtain a plurality of input parameters; performing corresponding data mapping processing on each of the input parameters to obtain a plurality of output variables; and performing data integration processing on the plurality of output variables to obtain the index value.

In accordance with a second aspect of the present disclosure, an embodiment provides a forwarding chip, including a memory, a processor, and a computer program stored in the memory and executable by the processor, where the computer program, when executed by the processor, causes the processor to implement the data processing method in accordance with the first aspect.

In accordance with a third aspect of the present disclosure, an embodiment provides a computer-readable storage medium, storing computer-executable instructions which, when executed by a processor, cause the processor to implement the data processing method described above.

In accordance with a fourth aspect of the present disclosure, an embodiment provides a computer program product, including a computer program or computer instructions stored in a computer-readable storage medium, where the computer program or the computer instructions, when read from the computer-readable storage medium and executed by a processor of a computer device, cause the computer device to implement the data processing method described above.

Additional features and advantages of the present disclosure will be set forth in the description which follows, and in part will be obvious from the description, or may be learned by the practice of the present disclosure. The objects and other advantages of the present disclosure can be realized and obtained by the structures particularly pointed out in the description, claims and drawings.

### BRIEF DESCRIPTION OF DRAWINGS

The drawings are provided for a further understanding of the technical schemes of the present disclosure, and constitute a part of the description. The drawings and the embodiments of the present disclosure are used to illustrate the technical schemes of the present disclosure, but are not intended to limit the technical schemes of the present disclosure.

FIG. 1 is a flowchart of a data processing method according to an embodiment of the present disclosure;

FIG. 2 is a schematic diagram of non-last round mapping processing according to an embodiment of the present disclosure;

FIG. 3 is a schematic diagram of last round mapping processing according to an embodiment of the present disclosure;

FIG. 4 is a flowchart of an implementation of S120 in FIG. 1;

FIG. 5 is a flowchart of an implementation of S210 in FIG. 4;

FIG. 6 is a flowchart of another implementation of S210 in FIG. 4;

FIG. 7 is a flowchart of an implementation of S140 in FIG. 1;

FIG. 8 is a schematic diagram of a data processing method according to an example of the present disclosure; and

FIG. 9 is a schematic structural diagram of a forwarding chip according to an embodiment of the present disclosure.

### DETAILED DESCRIPTION

To make the objects, technical schemes, and advantages of the present disclosure clear, the present disclosure is described in further detail in conjunction with accompanying drawings and examples. It should be understood that the specific embodiments described herein are merely used for illustrating the present disclosure, and are not intended to limit the present disclosure.

It is to be noted, although logical orders have been shown in the flowcharts, in some cases, the steps shown or described may be executed in an order different from the orders as shown in the flowcharts. In the description of the specification, claims, and the accompanying drawings, the term “a plurality of” (or multiple) means at least two, the term such as “greater than”, “less than”, “exceed” or variants thereof prior to a number or series of numbers is understood to not include the number adjacent to the term. The term “at least” prior to a number or series of numbers is understood to include the number adjacent to the term “at least”, and all subsequent numbers or integers that could logically be included, as clear from context. If used herein, the terms such as “first” and “second” are merely used for distinguishing technical features, and are not intended to indicate or imply relative importance, or implicitly point out the number of the indicated technical features, or implicitly point out the order of the indicated technical features.

The present disclosure provides a data processing method, a forwarding chip, a storage medium, and a program product. The method includes: acquiring an input parameter, where the input parameter is used for generating an index value to be filled in a hash table; performing data replication processing on the input parameter to obtain a plurality of input parameters; performing corresponding data mapping processing on the input parameters to obtain a plurality of output variables; and performing data integration processing on the plurality of output variables to obtain the index value. In other words, data replication processing is performed on the input parameter to obtain a plurality of input parameters, and parallel data mapping processing is performed on the plurality of input parameters to obtain a mixture of a plurality of output variables. Such a design structure reduces time delay of a critical path of a fully unrolled circuit. Therefore, through the mixing of the plurality of output variables, the number of algorithm rounds required to ensure the independence of output bits is effectively reduced, thereby reducing the algorithm delay. Because the correlation between different output variables obtained from corresponding data mapping processing performed on the input parameters is low, bits in the index value obtained from data integration processing performed on the plurality of output variables have a low correlation, so that the impact on the stability of the optimal fill rate is reduced. Therefore, the scheme of the embodiments of the present disclosure can reduce the correlation between the bits in the index value and the number of algorithm rounds required to ensure the independence of output bits, such that the impact on the stability of the optimal fill rate and the algorithm delay can be reduced.

The embodiments of the present disclosure will be further described in detail below in conjunction with the accompanying drawings.

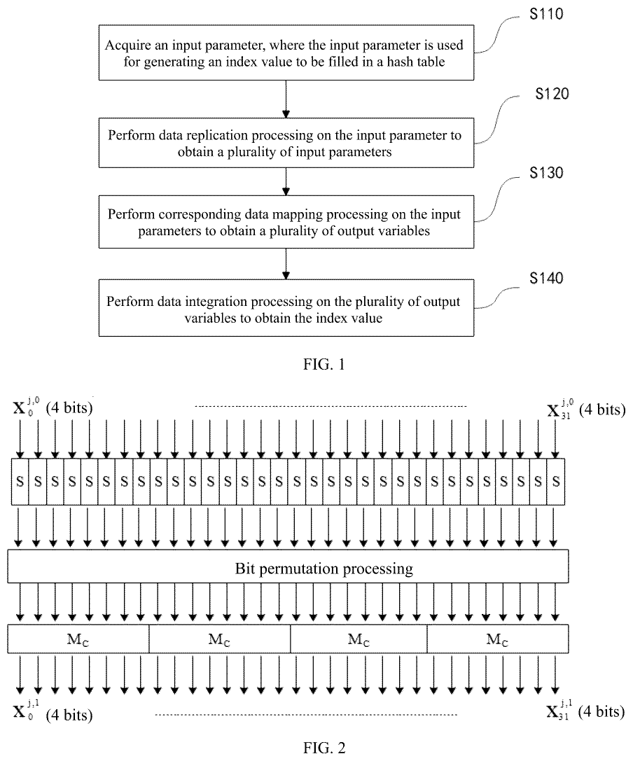

FIG. 1 is a flowchart of a data processing method according to an embodiment of the present disclosure. As shown in FIG. 1, the data processing method may include, but not limited to, the following steps S110, S120, S130, and S140.

At S110, an input parameter is acquired, where the input parameter is used for generating an index value to be filled in a hash table.

In this step, the input parameter may be of any length, e.g., 16 bits, 32 bits, 128 bits, 512 bits, or other numbers of bits, etc., which is not particularly limited herein.

At S120, data replication processing is performed on the input parameter to obtain a plurality of input parameters.

Because a plurality of input parameters are obtained by performing data replication processing on the input parameter in this step, different data mapping processing can be performed on the plurality of input parameters in parallel in subsequent steps.

At S130, corresponding data mapping processing is performed on the input parameters to obtain a plurality of output variables.

In this step, because a plurality of input parameters are obtained by performing data replication processing on the input parameter in S120, corresponding data mapping processing can be performed on the input parameters at the same time to obtain a plurality of output variables. In other words, the number of algorithm rounds required to ensure the independence of output bits can be reduced by mixing output variables outputted by a plurality of branches, thereby reducing the algorithm delay.

It should be noted that the data mapping processing includes non-last round mapping processing and last round mapping processing. The non-last round mapping processing includes Substitution-box (S-box) processing, bit permutation processing, and matrix multiplication processing, and the last round mapping processing includes the S-box processing and the bit permutation processing. The bit permutation processing varies with different data mapping processing. Because the design of a partial linear layer is adopted in the last round mapping processing, i.e., only S-box processing and bit permutation processing are performed and matrix multiplication processing is not performed, this embodiment can further optimize the processing delay and the circuit area for implementing the algorithm while keeping the independence of output bits of the algorithm unchanged.

It should be noted that, the bit permutation processing varies with different data mapping processing, reflected by the value of the bit permutation processing varying with different data mapping processing.

It should be noted that in cryptography, an S-box is a basic component of symmetric key algorithms which performs substitution, and the function of the S-box is a simple “replacement” operation.

It should be noted that the number of times the corresponding data mapping processing is performed on the input parameters is not limited, and the number of times the non-last round mapping processing is performed may be 2, 3, etc., which is not particularly limited herein.

It should be noted that in this embodiment, corresponding data mapping processing is performed on the input parameters, such that the data processing method maintains satisfactory diffusion and obfuscation capabilities. In other words, the classical Substitution-Permutation Network (SPN) structure is used in the design of each branch algorithm, such that the data processing method maintains satisfactory diffusion and obfuscation capabilities.

In an embodiment, during the non-last round mapping processing, an output parameter of the S-box processing in a current round mapping processing is used as an input parameter of the bit permutation processing, an output parameter of the bit permutation processing is used as an input parameter of the matrix multiplication processing, and an output parameter of the matrix multiplication processing is used as an input parameter of the S-box processing in a next round mapping processing. During the last round mapping processing, an output parameter of the matrix multiplication processing in a previous round mapping processing is used as an input parameter of the S-box processing in the last round mapping processing, and an output parameter of the S-box processing is used as an input parameter of the bit permutation processing.

In an embodiment, referring to FIG. 2, assuming that the input parameter has 128 bits (for the input parameter exceeding 128 bits, the input parameter can be padded with zeros to an integer multiple of 128 bits, and split into a plurality of the input parameters to be processed of 128 bits, and then an exclusive OR processing is performed on the plurality of parameters to be processed to obtain the compressed input parameter), data replication processing is performed on the input parameter to obtain a plurality of input parameters (i.e., input parameters of a plurality of branches), and the input parameter of each branch is split into 32 first temporary variables of a nibble (4 bits), i.e., input parameters of S-box processing S. If two rounds of data mapping processing are performed on the input parameter of a j^{th} branch, in the non-last round mapping processing, i.e., in the first round of data mapping processing, the input parameters of the S-box processing S in the current round of mapping processing are x₀^{j,r}, . . . , x₃₁^{j,r}, where r represents a serial number of the previous round of data mapping processing, 0≤r<2, and x₀^{j,r}, . . . , x₃₁^{j,r} are each of 4 bits, and j represents a serial number of one of the plurality of branches. When r=0, i.e., when the first round of data mapping processing is performed, the input parameters x₀^{j,0}, . . . , x₃₁^{j,0} of the S-box processing are subjected to S-box processing to obtain output parameters of the S-box processing (i.e., input parameters of bit permutation processing). Then, the output parameters of the S-box processing are subjected to bit permutation processing to obtain output parameters of the bit permutation processing (i.e., input parameters of matrix multiplication processing). The output parameters of the bit permutation processing are subjected to matrix multiplication processing (i.e., the bits of the output parameters of the bit permutation processing are divided into four parts, and an exclusive OR operation is respectively performed between the four parts and a preset matrix M_{C}) to obtain output parameters of the matrix multiplication processing, i.e., x₀^{j,1}, . . . , x₃₁^{j,1}. Then, the output parameters x₀^{j,1}, . . . , x₃₁^{j,1} of the matrix multiplication processing are subjected to the second round of data mapping processing (i.e., the last round mapping processing).

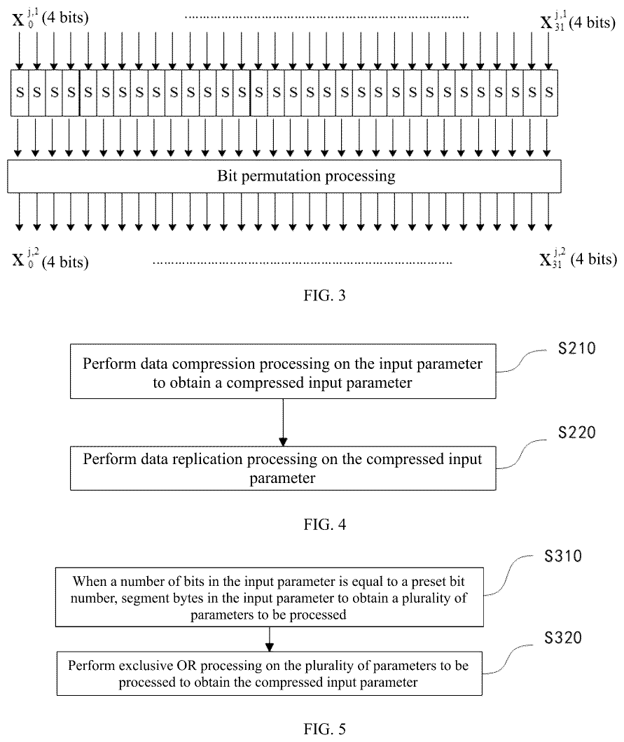

In an embodiment, referring to FIG. 3, during the last round mapping processing which does not include matrix multiplication processing, assuming that the output parameters of the matrix multiplication processing in the previous round of mapping processing are x₀^{j,1}, . . . , x₃₁^{j,1}, x₀^{j,1}, . . . , x₃₁^{j,1} are subjected to S-box processing to obtain output parameters of the S-box processing (i.e., input parameters of bit permutation processing). Then, the output parameters of the S-box processing are subjected to bit permutation processing to obtain output parameters of the bit permutation processing, i.e., output variables x₀^{j,2}, . . . , x₃₁^{j,2} of the j^{th} branch. Thus, the two rounds of data mapping processing are completed. j represents a serial number of one of the plurality of branches, r represents a serial number of the previous round of data mapping processing, and 0≤r<2.

In an embodiment, the S-box processing includes:
performing splitting processing on the input parameter to obtain a plurality of first temporary variables;
obtaining a plurality of second temporary variables according to the plurality of first temporary variables and a preset substitution table; and
performing integration processing on the plurality of second temporary variables to obtain a first substitution permutation variable.

It should be noted that the preset substitution table may be expressed in a decimal form, a hexadecimal form, or a binary form, etc., which is not particularly limited herein.

In an embodiment, assuming that data replication processing is performed on the input parameter to obtain input parameters of J branches, R rounds of mapping processing are performed on the input parameters of the branches, and each input parameter has a bit length of 128. The 128 bits of the input parameter may be split into 32 first temporary variables. The first temporary variables t may be expressed as:

$$t = {x}_{j}^{( r )} [ 4 i ] ‖ {x}_{j}^{( r )} [ 4 i + 1 ] ‖ {x}_{j}^{( r )} [ 4 i + 2 ] ‖ {x}_{j}^{( r )} [ 4 i + 3 ] . \qquad ( 1 )$$

In formula (1), xⱼ^{(r)}[4i], xⱼ^{(r)}[4i+1], xⱼ^{(r)}[4i+2], and xⱼ^{(r)}[4i+3] are values of four consecutive bits, i.e., the first temporary variable t is a value obtained by integrating the values of four consecutive bits in the input parameter.

If each of the first temporary variables t is permuted using a same preset substitution table, the second temporary variable s may be expressed as:

$$s = {y}_{j}^{( r )} [ 4 i ] ‖ {y}_{j}^{( r )} [ 4 i + 1 ] ‖ {y}_{j}^{r} [ 4 i + 2 ] ‖ {y}_{j}^{( r )} [ 4 i + 3 ] . \qquad ( 2 )$$

In formula (2), yⱼ^{(r)}[4i], yⱼ^{(r)}[4i+1], yⱼ^{(r)}[4i+2], and yⱼ^{(r)}[4i+3] are values of four consecutive bits. In formula (1) and formula (2), ∥ represents a concatenation operation; i represents a serial number of a bit, and 0≤i<32; j represents a serial number of a branch, and 0≤j<J; and r represents a serial number of the previous round of data mapping processing, and 0≤r<R.

It should be noted that J represents the total number of branches of the input parameters obtained by performing data replication processing on the input parameter, and J may be an arbitrary value. Similarly, R represents the number of times of different data mapping processing performed for a first intermediate variable, and R may be an arbitrary value, for example, R≥2.5, which is not particularly limited herein.

To more clearly describe the process of the S-box processing, examples are given below.

### Example One

TABLE 1
Decimal substitution table

| x | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| S(x) | 4 | 0 | 2 | 1 | 6 | 8 | 3 | 13 | 12 | 10 | 14 | 11 | 15 | 9 | 7 | 5 |

Referring to Table 1, x in Table 1 represents the first temporary variable, and S(x) represents the second temporary variable. Assuming that the input parameter is 0xe847d4140d779a657028602bd4c29b16, the input parameter is split into a plurality of first temporary variables, i.e., 0xe847d4140d779a657028602bd4c29b16 is split into e, 8, 4, . . . , b, 1, and 6. The first temporary variables are first converted into a decimal format, i.e., e, 8, 4, . . . , b, 1, and 6 are correspondingly converted into 14, 8, 4, . . . , 11, 1, and 6. Then, 14, 8, 4, . . . , 11, 1, and 6 are respectively replaced according to Table 1 to obtain 7, 12, 6, . . . , 11, 0, and 3. In other words, when x=14, S(x)=7; when x=8, S(x)=12; . . . ; when x=6, S(x)=3, and so on. Then, 7, 12, 6, . . . , 11, 0, and 3 are converted into a hexadecimal format to obtain a plurality of second temporary variables, i.e., the plurality of second temporary variables are 7, c, 6, . . . , b, 0, and 3. The plurality of second temporary variables are integrated to obtain a final first substitution permutation variable 0x7c6d960649ddae38d42c342b96f2ab03.

### Example Two

TABLE 2
Hexadecimal substitution table

| x | 0 | 1 | 2 | 3 | 4 | 5 | 6 | 7 | 8 | 9 | e | b | c | d | e | f |
|---|---|---|---|---|---|---|---|---|---|---|---|---|---|---|---|---|
| S(x) | 4 | 0 | 2 | 1 | 6 | 8 | 3 | d | c | a | e | b | f | 9 | 7 | 5 |

Referring to Table 2, x in Table 2 represents the first temporary variable, and S(x) represents the second temporary variable. Assuming that the input parameter is 0xe847d4140d779a657028602bd4c29b16, the input parameter is split into a plurality of first temporary variables, i.e., 0xe847d4140d779a657028602bd4c29b1 6is split into e, 8, 4, . . . , b, 1, and 6. The first temporary variables e, 8, 4, . . . , b, 1, and 6 are replaced according to Table 2 to obtain a plurality of second temporary variables. The plurality of second temporary variables are 7, c, 6, . . . , b, 0, and 3. In other words, when x=e, S(x)=7; when x=8, S(x)=c; . . . ; when x=6, S(x)=3, and so on. Then, the plurality of second temporary variables are integrated to finally obtain a first substitution permutation variable 0x7c6d960649ddae38d42c342b96f2ab03.

In an embodiment, the bit permutation processing includes:
obtaining a target position corresponding to each bit in the first substitution permutation variable according to a preset bit permutation table and a value of the bit; and
performing position adjustment processing for each bit in the first substitution permutation variable according to the target position to obtain a second substitution permutation variable.

In an embodiment, it is assumed that the bit length of the input parameter is 128, and R rounds of data mapping processing are performed, where R represents the number of times of different data mapping processing performed for the first intermediate variable. If four input parameters are obtained by performing data replication processing on the input parameter, the four input parameters are subjected to S-box processing to obtain four first substitution permutation variables. Therefore, according to the first substitution permutation variable and the following formula (3), values zⱼ^{(r)}[P_{b,j}[i]] of bits in the corresponding second substitution permutation variable are calculated, i.e.,

$${z}_{j}^{( r )} [ {P}_{b , j} [ i ] ] = {y}_{j}^{( r )} [ i ] . \qquad ( 3 )$$

In formula (3), i represents a serial number of a bit, and 0≤i<128; j represents a serial number of a branch, and 0≤j<4; r represents a serial number of the previous round of data mapping processing, and 0≤r<R; P_{b,j}[i] represents a serial number (i.e., a target position) of each bit in the second substitution permutation variable; and yⱼ^{(r)}[i] represents a value of each bit in the first substitution permutation variable.

In an embodiment, referring to a preset bit permutation table shown in Table 3, i represents a serial number of a bit in the first substitution permutation variable, P_{b,0}[i] represents a serial number of a bit in a second substitution permutation variable of a first branch, P_{b,1}[i] represents a serial number of a bit in a second substitution permutation variable of a second branch, P_{b,2}[i] represents a serial number of a bit in a second substitution permutation variable of a third branch, P_{b,3}[i] represents a serial number of a bit in a second substitution permutation variable of a fourth branch, where 0≤i<127.

Assuming that a first substitution permutation variable of the first branch is 0x7c6d960649ddae38d42c342b96f2ab03, if i=0, it can be learned from Table 3 and formula (3) that z₀^{(r)}[P_{b,0}[0]] =z₀^{(r)}[6] =y₀^{(r)}[0], i.e., bit 0 in the first substitution permutation variable corresponds to bit 6 in the preset bit permutation table. It can be learned from the first substitution permutation variable that values of the first eight bits of the first substitution permutation variable are 01111100, the value of bit 6 in the second substitution permutation variable (i.e.,

[symbol] [[y]]z

[symbol] 0

[symbol] (r)

[symbol]

[symbol] 6

[symbol] =0) is the value of bit 0 in the first substitution permutation variable (i.e.,

[symbol] [[z]] y

[symbol] 0

[symbol] (r)

[symbol]

[symbol] 0

=0), and so on. Therefore, the permutation result is 01111100. After the above operations are performed 128 times, the finally obtained second substitution permutation variable is 0x35c4f873b69f8e222aeba00d792c818f. This is not particularly limited in this embodiment.

TABLE 3
Preset bit permutation table

| i | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| P_{b, 0} | 6 | 46 | 62 | 126 | 70 | 52 | 28 | 14 | 36 | 125 | 72 | 83 | 106 | 95 | 4 | 35 |
| P_{b, 1} | 20 | 122 | 74 | 62 | 119 | 35 | 15 | 66 | 9 | 85 | 32 | 117 | 21 | 83 | 127 | 106 |
| P_{b, 2} | 0 | 53 | 87 | 73 | 22 | 95 | 99 | 48 | 61 | 36 | 108 | 1 | 124 | 67 | 119 | 93 |
| P_{b, 3} | 76 | 30 | 53 | 35 | 31 | 46 | 2 | 79 | 11 | 125 | 110 | 87 | 39 | 91 | 14 | 101 |

| i | 16 | 17 | 18 | 19 | 20 | 21 | 22 | 23 | 24 | 25 | 26 | 27 | 28 | 29 | 30 | 31 |
|---|---|---|---|---|---|---|---|---|---|---|---|---|---|---|---|---|
| P_{b, 0} | 25 | 41 | 10 | 76 | 87 | 74 | 120 | 42 | 88 | 21 | 11 | 67 | 64 | 38 | 112 | 50 |
| P_{b, 1} | 11 | 98 | 115 | 59 | 71 | 90 | 56 | 26 | 2 | 44 | 103 | 121 | 114 | 107 | 68 | 16 |
| P_{b, 2} | 54 | 103 | 69 | 112 | 16 | 111 | 94 | 122 | 31 | 66 | 33 | 83 | 47 | 3 | 65 | 62 |
| P_{b, 3} | 97 | 118 | 36 | 48 | 29 | 80 | 57 | 115 | 49 | 18 | 74 | 85 | 61 | 82 | 105 | 126 |

| i | 32 | 33 | 34 | 35 | 36 | 37 | 38 | 39 | 40 | 41 | 42 | 43 | 44 | 45 | 46 | 47 |
|---|---|---|---|---|---|---|---|---|---|---|---|---|---|---|---|---|
| P_{b, 0} | 85 | 109 | 24 | 65 | 99 | 0 | 49 | 37 | 8 | 66 | 114 | 47 | 127 | 100 | 56 | 40 |
| P_{b, 1} | 84 | 1 | 102 | 33 | 80 | 52 | 76 | 36 | 27 | 94 | 37 | 55 | 82 | 12 | 112 | 64 |
| P_{b, 2} | 123 | 9 | 101 | 19 | 5 | 58 | 89 | 37 | 38 | 51 | 28 | 106 | 82 | 76 | 121 | 4 |
| P_{b, 3} | 70 | 12 | 47 | 111 | 51 | 17 | 66 | 1 | 60 | 96 | 116 | 71 | 81 | 114 | 104 | 15 |

| i | 48 | 49 | 50 | 51 | 52 | 53 | 54 | 55 | 56 | 57 | 58 | 59 | 60 | 61 | 62 | 63 |
|---|---|---|---|---|---|---|---|---|---|---|---|---|---|---|---|---|
| P_{b, 0} | 13 | 117 | 78 | 86 | 92 | 58 | 124 | 101 | 55 | 89 | 97 | 918 | 116 | 59 | 15 | 13 |
| P_{b, 1} | 105 | 14 | 91 | 17 | 108 | 124 | 6 | 93 | 29 | 86 | 123 | 79 | 72 | 53 | 19 | 99 |
| P_{b, 2} | 70 | 7 | 42 | 92 | 104 | 80 | 45 | 75 | 114 | 17 | 2 | 97 | 46 | 107 | 63 | 18 |
| P_{b, 3} | 42 | 124 | 100 | 4 | 113 | 44 | 75 | 89 | 23 | 0 | 84 | 107 | 32 | 26 | 88 | 8 |

| i | 64 | 65 | 66 | 67 | 68 | 69 | 70 | 71 | 72 | 73 | 74 | 75 | 76 | 77 | 78 | 79 |
|---|---|---|---|---|---|---|---|---|---|---|---|---|---|---|---|---|
| P_{b, 0} | 20 | 45 | 75 | 2 | 77 | 27 | 1 | 60 | 115 | 107 | 26 | 69 | 119 | 3 | 84 | 51 |
| P_{b, 1} | 50 | 18 | 81 | 73 | 67 | 88 | 4 | 61 | 111 | 49 | 24 | 45 | 57 | 78 | 100 | 22 |
| P_{b, 2} | 109 | 15 | 127 | 43 | 13 | 59 | 29 | 125 | 77 | 11 | 50 | 30 | 12 | 90 | 118 | 64 |
| P_{b, 3} | 69 | 121 | 38 | 94 | 37 | 86 | 54 | 21 | 62 | 123 | 41 | 10 | 16 | 95 | 117 | 65 |

| i | 80 | 81 | 82 | 83 | 84 | 85 | 86 | 87 | 88 | 89 | 90 | 91 | 92 | 93 | 94 | 95 |
|---|---|---|---|---|---|---|---|---|---|---|---|---|---|---|---|---|
| P_{b, 0} | 123 | 110 | 31 | 82 | 113 | 53 | 81 | 102 | 63 | 118 | 93 | 12 | 30 | 94 | 108 | 32 |
| P_{b, 1} | 110 | 47 | 116 | 54 | 60 | 70 | 97 | 39 | 3 | 41 | 48 | 96 | 23 | 42 | 113 | 87 |
| P_{b, 2} | 20 | 35 | 57 | 10 | 124 | 56 | 68 | 91 | 116 | 21 | 84 | 98 | 52 | 81 | 126 | 34 |
| P_{b, 3} | 45 | 50 | 72 | 20 | 109 | 58 | 7 | 67 | 108 | 28 | 3 | 55 | 92 | 103 | 24 | 5 |

| i | 96 | 97 | 98 | 99 | 100 | 101 | 102 | 103 | 104 | 105 | 106 | 107 | 108 | 109 | 110 | 111 |
|---|---|---|---|---|---|---|---|---|---|---|---|---|---|---|---|---|
| P_{b, 0} | 5 | 111 | 29 | 43 | 91 | 19 | 79 | 33 | 73 | 44 | 98 | 48 | 22 | 61 | 68 | 105 |
| P_{b, 1} | 126 | 13 | 31 | 40 | 51 | 25 | 65 | 125 | 8 | 101 | 118 | 28 | 38 | 89 | 5 | 104 |
| P_{b, 2} | 105 | 27 | 120 | 74 | 6 | 85 | 40 | 72 | 113 | 41 | 23 | 49 | 79 | 55 | 102 | 8 |
| P_{b, 3} | 77 | 9 | 27 | 102 | 122 | 6 | 106 | 22 | 99 | 34 | 90 | 56 | 43 | 83 | 120 | 64 |
| i | 112 | 113 | 114 | 115 | 116 | 117 | 118 | 119 | 120 | 121 | 122 | 123 | 124 | 125 | 126 | 127 |
| P_{b, 0} | 34 | 71 | 54 | 104 | 17 | 57 | 80 | 103 | 96 | 121 | 23 | 39 | 122 | 90 | 7 | 16 |
| P_{b, 1} | 109 | 120 | 69 | 43 | 7 | 77 | 58 | 34 | 10 | 63 | 30 | 95 | 75 | 46 | 0 | 92 |
| P_{b, 2} | 117 | 39 | 88 | 26 | 25 | 110 | 14 | 32 | 115 | 100 | 86 | 71 | 78 | 44 | 96 | 60 |
| P_{b, 3} | 78 | 59 | 119 | 93 | 40 | 98 | 52 | 68 | 112 | 33 | 63 | 25 | 19 | 73 | 127 | 13 |

In addition, in an embodiment, the matrix multiplication processing includes:
segmenting bits in the second substitution permutation variable to obtain a plurality of third temporary variables having a first data length;
performing bitwise exclusive OR processing between each of the third temporary variables and each row of matrix elements in a preset matrix to obtain a plurality of fourth temporary variables, where a length of each row of elements and a length of each column of elements in the preset matrix are equal to the first data length; and
performing integration processing on the plurality of fourth temporary variables to obtain a third substitution permutation variable.

In an embodiment, assuming that the bit length of the second substitution permutation variable is 128, the bits in the second substitution permutation variable are split into four 32-bit third temporary variables. Based on the third temporary variables and the following formula (4), values x[i] of bits in the fourth temporary variables are calculated, i.e.,

$$x [ i ] = {⊕}_{m = 0}^{31} ( {M}_{b} [ i ] [ m ] \cdot z [ m ] ) . \qquad ( 4 )$$

In formula (4), M_{b}[i][m] represents an element of a row i and a column m of a preset matrix M_{b}, z[m] represents a value of bit m in the third temporary variable, and i represents a serial number of a bit, where 0≤i<32. The preset matrix M_{b} is shown in Table 4 below.

In an embodiment, if the values of the bits in the 32-bit fourth temporary variables are expressed as x[0], . . . , x[31], and when i=0,

$$\begin{matrix}x [ 0 ] = {⊕}_{m = 0}^{31} ( {M}_{b} [ 0 ] [ m ] \cdot z [ m ] ) \\ = ( {M}_{b} [ 0 ] [ 0 ] \cdot z [ 0 ] ) ⊕ … ⊕ ( {M}_{b} [ 0 ] [ 31 ] \cdot z [ 31 ] ) \\ = ( 0 \cdot z [ 0 ] ) ⊕ … ⊕ ( 1 \cdot z [ 31 ] ) \\ = z [ 15 ] ⊕ z [ 20 ] ⊕ z [ 31 ]\end{matrix} . \qquad ( 5 )$$

If the 1st third temporary variable is 0011 0101 1100 0100 1111 1000 0111 0011, i.e., z[0]=0, z[1]=0, . . . , z[31]=1, the value x[0] of bit 0 in the fourth temporary variable can be obtained from formula (5):

$$\begin{matrix}x [ 0 ] = z [ 15 ] ⊕ z [ 20 ] ⊕ z [ 31 ] \\ = 0 ⊕ 1 ⊕ 1 = 0\end{matrix} .$$

TABLE 4
Preset matrix M_{b}

| | | | | | | | | | | | | | | | |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 1 |
| 0 | 0 | 0 | 0 | 0 | 0 | 0 | 0 | 1 | 0 | 0 | 0 | 0 | 0 | 0 | 0 |
| 0 | 0 | 0 | 0 | 0 | 0 | 0 | 0 | 0 | 1 | 0 | 0 | 0 | 0 | 0 | 0 |
| 0 | 0 | 0 | 0 | 0 | 0 | 0 | 0 | 0 | 0 | 1 | 0 | 0 | 0 | 0 | 0 |
| 0 | 0 | 0 | 0 | 0 | 0 | 0 | 0 | 0 | 0 | 0 | 1 | 0 | 0 | 0 | 0 |
| 0 | 0 | 0 | 0 | 0 | 0 | 0 | 0 | 0 | 0 | 0 | 0 | 1 | 0 | 0 | 0 |
| 0 | 0 | 0 | 0 | 0 | 0 | 0 | 0 | 0 | 0 | 0 | 0 | 0 | 1 | 0 | 0 |
| 0 | 0 | 0 | 0 | 0 | 0 | 0 | 0 | 0 | 0 | 0 | 0 | 0 | 0 | 1 | 0 |
| 0 | 0 | 0 | 0 | 0 | 0 | 0 | 1 | 0 | 0 | 0 | 0 | 0 | 0 | 0 | 0 |
| 1 | 0 | 0 | 0 | 0 | 0 | 0 | 0 | 0 | 0 | 0 | 0 | 0 | 0 | 0 | 0 |
| 0 | 1 | 0 | 0 | 0 | 0 | 0 | 0 | 0 | 0 | 0 | 0 | 0 | 0 | 0 | 0 |
| 0 | 0 | 1 | 0 | 0 | 0 | 0 | 0 | 0 | 0 | 0 | 0 | 0 | 0 | 0 | 0 |
| 0 | 0 | 0 | 1 | 0 | 0 | 0 | 0 | 0 | 0 | 0 | 0 | 0 | 0 | 0 | 0 |
| 0 | 0 | 0 | 0 | 1 | 0 | 0 | 0 | 0 | 0 | 0 | 0 | 0 | 0 | 0 | 0 |
| 0 | 0 | 0 | 0 | 0 | 1 | 0 | 0 | 0 | 0 | 0 | 0 | 0 | 0 | 0 | 0 |
| 0 | 0 | 0 | 0 | 0 | 0 | 1 | 0 | 0 | 0 | 0 | 0 | 0 | 0 | 0 | 0 |
| 0 | 0 | 0 | 0 | 1 | 0 | 0 | 0 | 0 | 0 | 0 | 0 | 0 | 0 | 0 | 1 |
| 0 | 0 | 0 | 0 | 0 | 1 | 0 | 0 | 1 | 0 | 0 | 0 | 0 | 0 | 0 | 0 |
| 0 | 0 | 0 | 0 | 0 | 0 | 1 | 0 | 0 | 1 | 0 | 0 | 0 | 0 | 0 | 0 |
| 0 | 0 | 0 | 0 | 0 | 0 | 0 | 1 | 0 | 0 | 1 | 0 | 0 | 0 | 0 | 0 |
| 1 | 0 | 0 | 0 | 0 | 0 | 0 | 0 | 0 | 0 | 0 | 1 | 0 | 0 | 0 | 0 |
| 0 | 1 | 0 | 0 | 0 | 0 | 0 | 0 | 0 | 0 | 0 | 0 | 1 | 0 | 0 | 0 |
| 0 | 0 | 1 | 0 | 0 | 0 | 0 | 0 | 0 | 0 | 0 | 0 | 0 | 1 | 0 | 0 |
| 0 | 0 | 0 | 1 | 0 | 0 | 0 | 0 | 0 | 0 | 0 | 0 | 0 | 0 | 1 | 0 |
| 0 | 0 | 0 | 0 | 0 | 0 | 0 | 1 | 0 | 0 | 0 | 0 | 1 | 0 | 0 | 0 |
| 1 | 0 | 0 | 0 | 0 | 0 | 0 | 0 | 0 | 0 | 0 | 0 | 0 | 1 | 0 | 0 |
| 0 | 1 | 0 | 0 | 0 | 0 | 0 | 0 | 0 | 0 | 0 | 0 | 0 | 0 | 1 | 0 |
| 0 | 0 | 1 | 0 | 0 | 0 | 0 | 0 | 0 | 0 | 0 | 0 | 0 | 0 | 0 | 1 |
| 0 | 0 | 0 | 1 | 0 | 0 | 0 | 0 | 1 | 0 | 0 | 0 | 0 | 0 | 0 | 0 |
| 0 | 0 | 0 | 0 | 1 | 0 | 0 | 0 | 0 | 1 | 0 | 0 | 0 | 0 | 0 | 0 |
| 0 | 0 | 0 | 0 | 0 | 1 | 0 | 0 | 0 | 0 | 1 | 0 | 0 | 0 | 0 | 0 |
| 0 | 0 | 0 | 0 | 0 | 0 | 1 | 0 | 0 | 0 | 0 | 1 | 0 | 0 | 0 | 0 |

| | | | | | | | | | | | | | | | |
|---|---|---|---|---|---|---|---|---|---|---|---|---|---|---|---|
| 0 | 0 | 0 | 0 | 1 | 0 | 0 | 0 | 0 | 0 | 0 | 0 | 0 | 0 | 0 | 1 |
| 0 | 0 | 0 | 0 | 0 | 1 | 0 | 0 | 1 | 0 | 0 | 0 | 0 | 0 | 0 | 0 |
| 0 | 0 | 0 | 0 | 0 | 0 | 1 | 0 | 0 | 1 | 0 | 0 | 0 | 0 | 0 | 0 |
| 0 | 0 | 0 | 0 | 0 | 0 | 0 | 1 | 0 | 0 | 1 | 0 | 0 | 0 | 0 | 0 |
| 1 | 0 | 0 | 0 | 0 | 0 | 0 | 0 | 0 | 0 | 0 | 1 | 0 | 0 | 0 | 0 |
| 0 | 1 | 0 | 0 | 0 | 0 | 0 | 0 | 0 | 0 | 0 | 0 | 1 | 0 | 0 | 0 |
| 0 | 0 | 1 | 0 | 0 | 0 | 0 | 0 | 0 | 0 | 0 | 0 | 0 | 1 | 0 | 0 |
| 0 | 0 | 0 | 1 | 0 | 0 | 0 | 0 | 0 | 0 | 0 | 0 | 0 | 0 | 1 | 0 |
| 0 | 0 | 0 | 0 | 0 | 0 | 0 | 1 | 0 | 0 | 0 | 0 | 1 | 0 | 0 | 0 |
| 1 | 0 | 0 | 0 | 0 | 0 | 0 | 0 | 0 | 0 | 0 | 0 | 0 | 1 | 0 | 0 |
| 0 | 1 | 0 | 0 | 0 | 0 | 0 | 0 | 0 | 0 | 0 | 0 | 0 | 0 | 1 | 0 |
| 0 | 0 | 1 | 0 | 0 | 0 | 0 | 0 | 0 | 0 | 0 | 0 | 0 | 0 | 0 | 1 |
| 0 | 0 | 0 | 1 | 0 | 0 | 0 | 0 | 1 | 0 | 0 | 0 | 0 | 0 | 0 | 0 |
| 0 | 0 | 0 | 0 | 1 | 0 | 0 | 0 | 0 | 1 | 0 | 0 | 0 | 0 | 0 | 0 |
| 0 | 0 | 0 | 0 | 0 | 1 | 0 | 0 | 0 | 0 | 1 | 0 | 0 | 0 | 0 | 0 |
| 0 | 0 | 0 | 0 | 0 | 0 | 1 | 0 | 0 | 0 | 0 | 1 | 0 | 0 | 0 | 0 |
| 0 | 0 | 0 | 0 | 0 | 0 | 0 | 0 | 0 | 0 | 0 | 0 | 0 | 0 | 0 | 1 |
| 0 | 0 | 0 | 0 | 0 | 0 | 0 | 0 | 1 | 0 | 0 | 0 | 0 | 0 | 0 | 0 |
| 0 | 0 | 0 | 0 | 0 | 0 | 0 | 0 | 0 | 1 | 0 | 0 | 0 | 0 | 0 | 0 |
| 0 | 0 | 0 | 0 | 0 | 0 | 0 | 0 | 0 | 0 | 1 | 0 | 0 | 0 | 0 | 0 |
| 0 | 0 | 0 | 0 | 0 | 0 | 0 | 0 | 0 | 0 | 0 | 1 | 0 | 0 | 0 | 0 |
| 0 | 0 | 0 | 0 | 0 | 0 | 0 | 0 | 0 | 0 | 0 | 0 | 1 | 0 | 0 | 0 |
| 0 | 0 | 0 | 0 | 0 | 0 | 0 | 0 | 0 | 0 | 0 | 0 | 0 | 1 | 0 | 0 |
| 0 | 0 | 0 | 0 | 0 | 0 | 0 | 0 | 0 | 0 | 0 | 0 | 0 | 0 | 1 | 0 |
| 0 | 0 | 0 | 0 | 0 | 0 | 0 | 1 | 0 | 0 | 0 | 0 | 0 | 0 | 0 | 0 |
| 1 | 0 | 0 | 0 | 0 | 0 | 0 | 0 | 0 | 0 | 0 | 0 | 0 | 0 | 0 | 0 |
| 0 | 1 | 0 | 0 | 0 | 0 | 0 | 0 | 0 | 0 | 0 | 0 | 0 | 0 | 0 | 0 |
| 0 | 0 | 1 | 0 | 0 | 0 | 0 | 0 | 0 | 0 | 0 | 0 | 0 | 0 | 0 | 0 |
| 0 | 0 | 0 | 1 | 0 | 0 | 0 | 0 | 0 | 0 | 0 | 0 | 0 | 0 | 0 | 0 |
| 0 | 0 | 0 | 0 | 1 | 0 | 0 | 0 | 0 | 0 | 0 | 0 | 0 | 0 | 0 | 0 |
| 0 | 0 | 0 | 0 | 0 | 1 | 0 | 0 | 0 | 0 | 0 | 0 | 0 | 0 | 0 | 0 |
| 0 | 0 | 0 | 0 | 0 | 0 | 1 | 0 | 0 | 0 | 0 | 0 | 0 | 0 | 0 | 0 |

At S140, data integration processing is performed on the plurality of output variables to obtain the index value.

In this embodiment, according to the data processing method including the above steps S110 to S140, first, an input parameter is acquired; next, data replication processing is performed on the input parameter to obtain a plurality of input parameters; then, corresponding data mapping processing is performed on the input parameters to obtain a plurality of output variables; and finally, data integration processing is performed on the plurality of output variables to obtain an index value. In other words, data replication processing is performed on the input parameter to obtain a plurality of input parameters, and parallel data mapping processing is performed on the plurality of input parameters to obtain a mixture of a plurality of output variables. Such a design structure reduces time delay of a critical path of a fully unrolled circuit. Therefore, through the mixing of the plurality of output variables, the number of algorithm rounds required to ensure the independence of output bits is effectively reduced, thereby reducing the algorithm delay. Because the correlation between different output variables obtained from corresponding data mapping processing performed on the input parameters is low, bits in the index value obtained from data integration processing performed on the plurality of output variables have a low correlation, so that the impact on the stability of the optimal fill rate is reduced. Therefore, the scheme of the embodiments of the present disclosure can reduce the correlation between the bits in the index value and the number of algorithm rounds required to ensure the independence of output bits, such that the impact on the stability of the optimal fill rate and the algorithm delay can be reduced.

It should be noted that although a Message Digest Algorithm (MD) structure based on a customized Hash function represented by Message Digest Algorithm 5 (MD5) can reduce the impact on the stability of the optimal fill rate, it has defects such as a large number of rounds and a long block length. As a result, the modular addition operation adopted in the algorithm is not conducive to hardware implementation, and further causes problems such as large hardware area and large delay. In addition, in this embodiment, the number of times that corresponding data mapping processing can be performed on the input parameters is not limited, and is, for example, 2.5, so that the number of times of data mapping processing can be reduced. In addition, in this embodiment, data compression processing is further performed on the input parameter to shorten the block length of the input parameter. Therefore, compared with a Hash function based on a plurality of MD structures, this embodiment not only reduces the algorithm delay, but also optimizes the circuit area for implementing the algorithm.

In an embodiment, as shown in FIG. 4, S120 is further described, and S120 may include, but not limited to, the following steps S210 and S220.

At S210, data compression processing is performed on the input parameter to obtain a compressed input parameter.

In this step, data compression processing may be performed on the input parameter to obtain a compressed input parameter. The compressed input parameter has a fixed bit length, which is conducive to supporting the variable length input of the algorithm. The compressed input parameter optimizes the circuit area for implementing the algorithm for subsequent calculations.

At S220, data replication processing is performed on the compressed input parameter.

In this embodiment, according to the data processing method including the above steps S210 and S220, first, data compression processing is performed on the input parameter to obtain a compressed input parameter, and then data replication processing is performed on the compressed input parameter. Therefore, this embodiment can optimize the circuit area for implementing the algorithm and reduce the algorithm delay.

In an embodiment, as shown in FIG. 5, S210 is further described, and S210 may include, but not limited to, the following steps S310 and S320.

At S310, when a number of bits in the input parameter is equal to a preset bit number, bytes in the input parameter are segmented to obtain a plurality of parameters to be processed.

At S320, exclusive OR processing is performed on the plurality of parameters to be processed to obtain the compressed input parameter.

In this embodiment, according to the data processing method including the above steps S310 and S320, the number of bits in the input parameter is first determined. When the number of bits in the input parameter is equal to the preset bit number, data compression processing may be performed on the input parameter, i.e., the bytes in the input parameter are segmented to obtain a plurality of parameters to be processed. Then, exclusive OR processing is performed on the plurality of parameters to be processed to obtain the compressed input parameter. Therefore, this embodiment can optimize the circuit area for implementing the algorithm.

It should be noted that the preset bit number may be an arbitrary value, e.g., 128, 512, 64, 32, or 16 bits, etc., which may be selected according to actual situations and is not particularly limited herein.

It can be understood that the segmentation of the bytes in the input parameter is equally segmenting the input parameter.

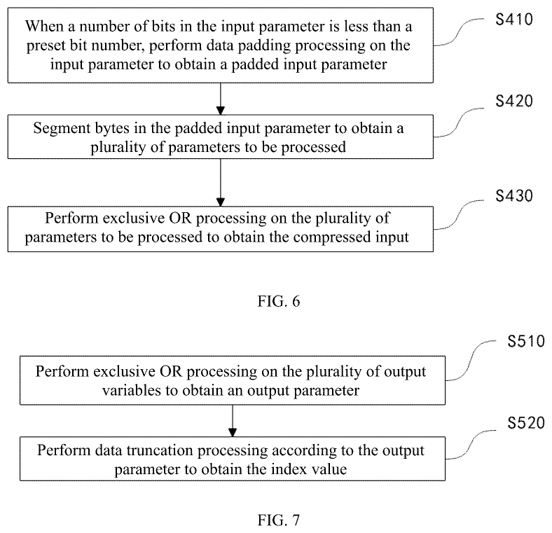

In another embodiment, as shown in FIG. 6, S210 is further described, and S210 may include, but not limited to, the following steps S410, S420, and S430.

At S410, when a number of bits in the input parameter is less than a preset bit number, data padding processing is performed on the input parameter to obtain a padded input parameter.

It should be noted that performing data padding processing on the input parameter may be padding higher bits in the input parameter with zeros such that the number of bits in the input parameter is equal to the preset bit number, or the data padding processing on the input parameter may be performed in other ways, which is not particularly limited herein.

At S420, bytes in the padded input parameter are segmented to obtain a plurality of parameters to be processed.

It can be understood that the segmentation of the bytes in the input parameter is equally segmenting the input parameter.

At S430, exclusive OR processing is performed on the plurality of parameters to be processed to obtain the compressed input parameter.

In this embodiment, according to the data processing method including the above steps S410 to S430, the number of bits in the input parameter is first determined. When the number of bits in the input parameter is less than the preset bit number, data padding processing may be performed on the input parameter to obtain a padded input parameter. Then, data compression processing is performed on the padded input parameter, i.e., the bytes in the padded input parameter are segmented to obtain a plurality of parameters to be processed. Then, exclusive OR processing is performed on the plurality of parameters to be processed to obtain the compressed input parameter. Therefore, this embodiment can optimize the circuit area for implementing the algorithm.

It should be noted that the embodiment shown in FIG. 5 and the embodiment shown in FIG. 6 are parallel embodiments and correspond to input parameters of different numbers of bits.

In an embodiment, as shown in FIG. 7, S140 is further described, and S140 may include, but not limited to, the following steps S510 and S520.

At S510, exclusive OR processing is performed on the plurality of output variables to obtain an output parameter.

Because corresponding data mapping processing is performed on the input parameters at the same time to obtain a plurality of output variables in S130, the output parameter obtained by performing exclusive OR processing on the plurality of output variables in this step is a mixture of the plurality of output variables. With such a design structure, the time consumed by performing different data mapping processing on the plurality of input parameters at the same time is not the sum of the time consumed by performing different data mapping processing on all the input parameters, but the maximum value of the time consumed by performing different data mapping processing on the plurality of input parameters at the same time. In other words, the critical path length of the fully unrolled circuit is not the sum of the delays of multiple branches, but the maximum value of the delays of the multiple branches. In addition, the number of algorithm rounds required to ensure the independence of output bits can be effectively reduced by mixing output parameters outputted by multiple branches, thereby reducing the algorithm delay.

At S520, data truncation processing is performed according to the output parameter to obtain the index value.

It should be noted that performing data truncation processing according to the output parameter to obtain the index value may be implemented in different manners. For example, the values of the bits in the output parameter may be arbitrarily truncated. Assuming that the output parameter is 11111100, the value of bit 1, the value of bit 3, the value of bit [[0]]5, and the value of bit 7 may be sequentially truncated, and the truncated values are integrated to obtain an index value 0111. Alternatively, assuming that the output parameter is 0xf4f91566d9b2d8c34f68ee5d0d20449c, the value of the eighth nibble, the value of the first nibble, and the value of the seventh nibble may be sequentially truncated, and the truncated values are integrated to obtain an index value 0x6f6. This is not particularly limited in this embodiment.

It should be noted that the output parameter and the index value may be presented in any form, e.g., in a binary form, in an octal form, in a decimal form, or in a hexadecimal form, which is not particularly limited herein.

It should also be noted that the length of the index value may be of any number of bits and may be set according to actual situations, which is not particularly limited in this embodiment.

The data processing method provided in the above embodiments will be described in detail below by way of examples.

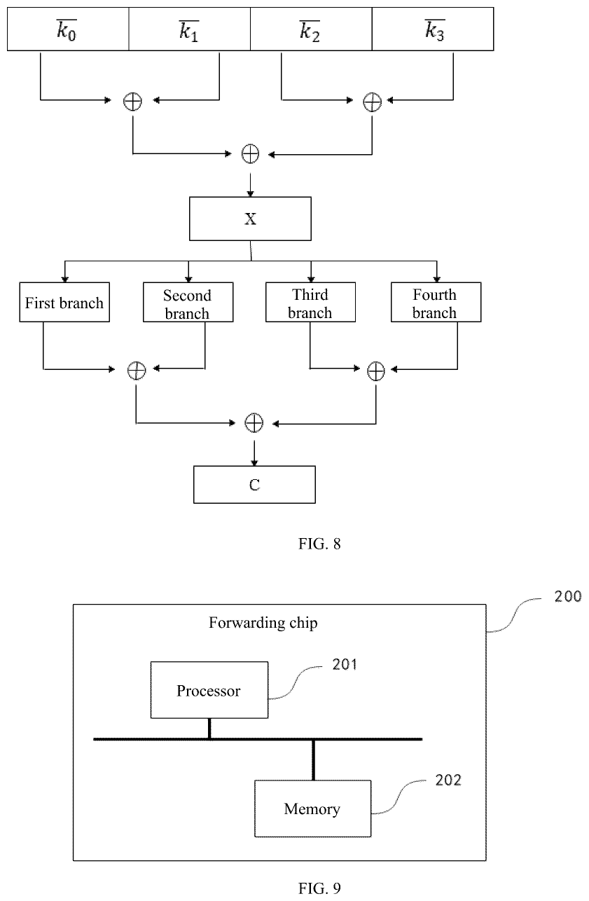

In an embodiment, referring to FIG. 8, it is assumed that the preset bit number is 512. If the number of bits in the input parameter is 145, data padding processing is performed on the input parameter, e.g., higher bits of the input parameter are padded with zeros, until the number of bits in the input parameter is equal to 512. If the number of bits in the input parameter is equal to 512, data padding processing does not need to be performed on the input parameter. The input parameter is expressed as k̅₀̅||k̅₁̅||k̅₂̅||k̅₃̅. Then, the bytes in the input parameter are segmented by 16 bytes (i.e., 128 bits) to obtain four parameters to be processed, namely, k̅₀̅, k̅₁̅, k̅₂̅,̅ k̅₃̅. Then, a compressed input parameter X may be obtained through calculation according to the four parameters to be processed and the following formula (6):

$$X ( \overline{{k}_{0}} ⊕ \overline{{k}_{1}} ) ⊕ ( \overline{{k}_{2}} ⊕ \overline{{k}_{3}} ) . \qquad ( 6 )$$

After the compressed input parameter X is calculated according to formula (6), X may be replicated into four 128-bit input parameters, namely, X₀, X₁, X₂, and X₃, X₀, X₁, X₂, and X₃ are processed by the first branch, the second branch, the third branch, and the fourth branch respectively. The number of rounds performed in each branch is defined as r, where r≥2.5, i.e., the smallest value of r is 2.5. Finally, four 128-bit output variables C₀, C₁, C₂, C₃ are obtained. Then, a 128-bit output parameter C may be obtained through calculation according to the four output variables and the following formula (7):

$$C = {C}_{0} ⊕ {C}_{1} ⊕ {C}_{2} ⊕ {C}_{3} . \qquad ( 7 )$$

In an embodiment, if the input parameter is 0xbabc22665930405d3d0bc0a0b86da94b600b8dff8260db9e4c73f31e4ee84a038ed5fbb6080e13 2fbd0e5230a5fad04abc25803bde291289bc5e01a587bda814, data compression processing is performed on the input parameter, i.e., bytes in the input parameter are segmented to obtain four parameters to be processed, namely, babc22665930405d3d0bc0a0b86da94b, 600b8dff8260db9e4c73f31e4ee84a03, 8ed5fbb6080e132fbd0e5230a5fad04a, and bc25803bde291289bc5e01a587bda814. Exclusive OR processing is performed on the four parameters to be processed according to formula (6) to obtain a compressed input parameter, as shown in Table 5, where the input parameters of the S-box processing are expressed as xⱼ^{(r)}; the input parameters of the bit permutation processing, i.e., the first substitution permutation variables, are expressed as yⱼ^{(r)}; and the input parameters of the matrix multiplication processing, i.e., the second substitution permutation variables, are expressed as zⱼ^{(r)}, j represents a serial number of a branch, 0≤j<4, r represents a serial number of the previous round of data mapping processing, and 0≤r<3.

TABLE 5
Test results of forwarding chips that execute the data processing method

| | key | | | |
|---|---|---|---|---|
| | 0xbabc22665930405d3d0bc0a0b86da94b600b8dff8260db9e4c73f31e4ee84a038ed5fb | | | |
| Branch | b6080e132fbd0e5230a5fad04abc25803bde291289bc5e01a587bda814 | | | |
| transform | Branch 0 | Branch 1 | Branch 2 | Branch 3 |
| xⱼ⁽⁰⁾ | 0xe847d4140d77 | 0xe847d4140d7 | 0xe847d4140d77 | 0xe847d4140d779a657028 |
| | 9a657028602bd4 | 79a657028602b | 9a657028602bd4 | 602bd4c29b16 |
| | c29b16 | d4c29b16 | c29b16 | |
| yⱼ⁽⁰⁾ | 0x7c6d960649dd | 0x7c6d960649d | 0x7c6d960649dd | 0x7c6d960649ddae38d42c3 |
| | ae38d42c342b96 | dae38d42c342b | ae38d42c342b96 | 42b96f2ab03 |
| | f2ab03 | 96f2ab03 | f2ab03 | |
| zⱼ⁽⁰⁾ | 0x35c4f873b69f | 0xc79825d8b88 | 0x3c6b03c0aef6 | 0x560d8883b1ea9ce80d96e |
| | 8e222aeba00d79 | 0a3f2cee3b5ba0 | 7ed85268ada7c2 | a3bde7261c5 |
| | 2c818f | 47c4b3a | edc402 | |
| xⱼ⁽¹⁾ | 0x54d188aa363e | 0x72fc5cf803a2 | 0xe5931629f0e5 | 0xcf5722bfc8181a3878400 |
| | b5e57995d1fbc9 | b285f71640839 | fd073d85c279bb | 69acd8336f8 |
| | 8446be | 7046360 | 23dbdd | |
| yⱼ⁽¹⁾ | 0x8690ccee1317 | 0xd25f8f5c41e2 | 0x78a1032a5478 | 0xf58d22b5fc0c0e1cdc644 |
| | b878daa8905bfa | b2c85d0364c1a | 594d19c8f2dabb | 3aef9c1135c |
| | c663b7 | d463134 | 219b99 | |
| zⱼ⁽¹⁾ | 0x675cad6e8fdd | 0x56116e772c5 | 0x03fe7f68d093 | 0x115852f2fd4b7c409e7d6 |
| | 4a84c967b3f8c9 | b108617c017f3 | 1c6c49f6210e20f | 61f17196072 |
| | 099310 | 0c70ac67 | 81ca6 | |
| xⱼ⁽²⁾ | 0xc3836fa008aa | 0xd56b560def7 | 0xbcb87bd13ea0 | 0x708e442442c45a74578dd |
| | 543ff4b2534bb5 | 62cabe83fe80c4 | f25f6ed4e85bee7 | 8abb39cc42a |
| | 2c10bd | 1264b57 | 42d91 | |
| yⱼ⁽²⁾ | 0xf1c135e44cee | 0x983b834975d | 0xbfbcdb9017e4 | 0xd4c7662662f68ed68dc99 |
| | 861556b2816bb8 | 32feb7c157c4f6 | 528537967c8b77 | cebb1aff62e |
| | 2f04b9 | 0236b8d | d629a0 | |
| zⱼ⁽²⁾ | 0xe6f787369b36 | 0x4734bf35e86f | 0xc120b2dfb6d4 | 0x941a9fba1c3f087be57eb |
| | 00e62c280894ba | 0baa96d2439e1 | dbf410ec17eb13 | 2bcb6dc6b95 |
| | 4c3a3f | 2a8ef99 | 18faaf | |
| Output | 0xf4f91566d9b2d8c34f68ee5d0d20449c | | | |
| value C | | | | |

For the data processing method provided in the above embodiments, test results of forwarding chips that execute the data processing method will be described in detail below by way of examples. It is assumed that the data processing method is a Chime algorithm.

### Test Result One

TABLE 6
Comparison of comprehensive hardware evaluation results
of CRC16 and Chime algorithms with the UMC 55 nm library

| | UMC55 nm | | | | |
|---|---|---|---|---|---|
| | | | Area/Bit | | |
| Version | Cell number | Area (GE) | (GE) | Delay (ns) | Freq (GHz) |
| CRC16_128 | 226 | 791 | 49.44 | 0.71 | 1.41 |
| Chime_128 | 6419 | 19652 | 153.53 | 0.72 | 1.39 |
| CRC16_512 | 881 | 4030 | 251.88 | 0.71 | 1.41 |
| Chime_512 | 6957 | 20315 | 158.71 | 0.94 | 1.06 |

As can be seen from Table 6, the bit width of the Hash value outputted by the CRC16 algorithm is 16 bits, and the bit width of the Hash value outputted by the Chime algorithm is 128 bits. When the input parameter is of 128 bits, the overall area (GE) of the Chime algorithm is about 25 times that of the CRC16 algorithm, the Area/Bit (GE) of the Chime algorithm is about 3 times that of the CRC16 algorithm, and the two algorithms have similar delays and frequencies. When the input parameter is of 512 bits, the overall area (GE) of the Chime algorithm is about 5 times that of the CRC16 algorithm, the Area/Bit (GE) of the Chime algorithm is about 6/10 that of the CRC16 algorithm, the delay of the Chime algorithm is slightly greater than that of the CRC16 algorithm, and the frequency of the Chime algorithm is slightly lower than that of the CRC16 algorithm. However, the Chime algorithm is also an algorithm suitable for chip implementation. CRC16_128 represents a CRC16 algorithm with an input parameter of 128 bits, Chime_128 represents a Chime algorithm with an input parameter of 128 bits, CRC16_512 represents a CRC16 algorithm with an input parameter of 512 bits, and Chime_512 represents a Chime algorithm with an input parameter of 512 bits.

It should be noted that Area/Bit represents an area per unit output bit, Area/Bit is equal to Area/output bit width, the output bit width of CRC16 is 16, and the output bit width of Chime is 128. The comparison of the areas of the algorithms is embodied in the area per output bit. The area per output bit represents the area required for outputting one bit.

### Test Result Two

TABLE 7
Test results of fill rates of MD5 and Chime algorithms
under different hash table configurations

| | | | Mean | Standard | Mean | Standard |
|---|---|---|---|---|---|---|
| | | Number of | fill | deviation of | fill | deviation of |
| Sub-table | Number of | sub-table | rate of | fill rates | rate of | fill rates |
| depth | sub-tables | collisions | MD5 | of MD5 | Chime | of Chime |
| 2¹² | 4 | 4 | 0.708 | 0.0197 | 0.711 | 0.0199 |
| 2¹² | 4 | 2 | 0.583 | 0.0281 | 0.566 | 0.0286 |
| 2¹⁰ | 2 | 4 | 0.730 | 0.0226 | 0.721 | 0.0239 |
| 2⁸ | 4 | 4 | 0.517 | 0.0515 | 0.500 | 0.0572 |

It can be seen from Table 7 that for different sub-table depths and different numbers of sub-tables, the mean and standard deviation of fill rates of the Chime algorithm are close to those of the MD5 algorithm. Therefore, the Chime algorithm is an algorithm that not only meets the requirements of chip implementation, but also can ensure the stability of the Hash table fill rate.

In addition, an embodiment of the present disclosure provides a forwarding chip 200. As shown in FIG. 9, the forwarding chip 200 includes, but not limited to,
a memory 202, configured for storing a program; and
a processor 201, configured for executing the program stored in the memory 202, where when the processor 201 executes the program stored in the memory 202, the processor 201 executes the data processing method described above.

The processor 201 and the memory 202 may be connected by a bus or in other ways.

The memory 202, as a non-transitory computer-readable storage medium, may be configured for storing a non-transitory software program and a non-transitory computer-executable program, for example, the data processing method described in the embodiments of the present disclosure. The processor 201 runs the non-transitory software program and the non-transitory computer-executable program stored in the memory 202, to implement the data processing method.

The memory 202 may include a program storage area and a data storage area. The program storage area may store an operating system, and an application required by at least one function. The data storage area may store data and the like required for executing the data processing method. In addition, the memory 202 may include a high-speed random access memory, and may also include a non-transitory memory, e.g., at least one magnetic disk storage device, flash memory device, or other non-transitory solid-state storage device. In some implementations, the memory 202 may include memories 202 located remotely from the processor 201, and the remote memories may be connected to the processor 201 via a network. Examples of the network include, but not limited to, the Internet, an intranet, a local area network, a mobile communication network, and combinations thereof.

The non-transitory software program and instructions required to implement the data processing method are stored in the memory 202 which, when executed by one or more processors 201, cause the one or more processors 201 to implement the data processing method, for example, implement the method steps S110 to S150 in FIG. 1, the method steps S210 and S220 in FIG. 4, the method steps S310 to S320 in FIG. 5, the method steps S410 to S430 in FIG. 6, or the method steps S510 and S520 in FIG. 7.

The apparatus embodiments or system embodiments described above are merely examples. The units described as separate components may or may not be physically separated, i.e., they may be located in one place or may be distributed over a plurality of network units. Some or all of the modules may be selected according to actual needs to achieve the objects of the scheme of this embodiment.

In addition, an embodiment of the present disclosure provides a computer-readable storage medium, storing a computer-executable instruction which, when executed by a processor or controller, for example, by a processor in the apparatus embodiment described above, may cause the processor to implement the data processing method of the foregoing embodiments, for example, implement the method steps S110 to S150 in FIG. 1, the method steps S210 and S220 in FIG. 4, the method steps S310 to S320 in FIG. 5, the method steps S410 to S430 in FIG. 6, or the method steps S510 and S520 in FIG. 7.

In addition, an embodiment of the present disclosure provides a computer program product, including a computer program or a computer instruction stored in a computer-readable storage medium, where the computer program or the computer instruction, when read from the computer-readable storage medium and executed by a processor of a computer device, causes the computer device to implement the data processing method in the above embodiments, for example, implement the method steps S110 to S150 in FIG. 1, the method steps S210 and S220 in FIG. 4, the method steps S310 to S320 in FIG. 5, the method steps S410 to S430 in FIG. 6, or the method steps S510 and S520 in FIG. 7.

Those having ordinary skills in the art can understand that all or some of the steps in the methods disclosed above and the functional modules/units in the system and the apparatus may be implemented as software, firmware, hardware, and appropriate combinations thereof. Some or all physical components may be implemented as software executed by a processor, such as a central processing unit, a digital signal processor, or a microprocessor, or as hardware, or as an integrated circuit, such as an application-specific integrated circuit. Such software may be distributed on a computer-readable medium, which may include a computer storage medium (or non-transitory medium) and a communication medium (or transitory medium). As is known to those having ordinary skills in the art, the term “computer storage medium” includes volatile and nonvolatile, removable and non-removable media implemented in any method or technology for storage of information (such as computer-readable instructions, data structures, program modules, or other data). The computer storage medium includes, but not limited to, a Random Access Memory (RAM), a Read-Only memory (ROM), an Electrically Erasable Programmable Read-Only Memory (EEPROM), a flash memory or other memory technology, a Compact Disc Read-Only Memory (CD-ROM), a Digital Versatile Disc (DVD) or other optical storage, a cassette, a magnetic tape, a magnetic disk storage or other magnetic storage device, or any other medium which can be used to store the desired information and can be accessed by a computer. In addition, as is known to those having ordinary skills in the art, the communication medium typically includes computer-readable instructions, data structures, program modules, or other data in a modulated data signal such as a carrier or other transport mechanism, and can include any information delivery medium.

Although some embodiments of the present disclosure have been described above, the present disclosure is not limited to the implementations described above. Those having ordinary skills in the art can make various equivalent modifications or replacements without departing from the essence of the present disclosure. Such equivalent modifications or replacements fall within the scope defined by the claims of the present disclosure.

1. A data processing method, comprising:
acquiring an input parameter used for generating an index value to be filled in a hash table;
performing data replication processing on the input parameter to obtain a plurality of input parameters;
performing corresponding data mapping processing on each of the plurality of input parameters to obtain a plurality of output variables; and
performing data integration processing on the plurality of output variables to obtain the index value.

2. The data processing method of claim 1, wherein the data mapping processing comprises non-last round mapping processing and last round mapping processing, the non-last round mapping processing comprises Substitution-box (S-box) processing, bit permutation processing, and matrix multiplication processing, and the last round mapping processing comprises the S-box processing and the bit permutation processing, wherein the bit permutation processing varies with different data mapping processing.

3. The data processing method of claim 2, wherein,
during the non-last round mapping processing, an output parameter of the S-box processing in a current round mapping processing is used as an input parameter of the bit permutation processing, an output parameter of the bit permutation processing is used as an input parameter of the matrix multiplication processing, and an output parameter of the matrix multiplication processing is used as an input parameter of the S-box processing in a next round mapping processing; and
during the last round mapping processing, an output parameter of the matrix multiplication processing in a previous round mapping processing is used as an input parameter of the S-box processing in the last round mapping processing, and an output parameter of the S-box processing is used as an input parameter of the bit permutation processing.

4. The data processing method of claim 2, wherein the S-box processing comprises:
performing splitting processing on the input parameter to obtain a plurality of first temporary variables;
obtaining a plurality of second temporary variables according to the plurality of first temporary variables and a preset substitution table; and
performing integration processing on the plurality of second temporary variables to obtain a first substitution permutation variable.

5. The data processing method of claim 2, wherein the bit permutation processing comprises:
obtaining a target position corresponding to each bit in the first substitution permutation variable according to a preset bit permutation table and a value of the bit; and
performing position adjustment processing for each bit in the first substitution permutation variable according to the target position to obtain a second substitution permutation variable.

6. The data processing method of claim 2, wherein the matrix multiplication processing comprises:
segmenting bits in the second substitution permutation variable to obtain a plurality of third temporary variables having a first data length;
performing bitwise exclusive OR processing between each of the third temporary variables and each row of matrix elements in a preset matrix to obtain a plurality of fourth temporary variables, wherein a length of each row of elements and a length of each column of elements in the preset matrix are equal to the first data length; and
performing integration processing on the plurality of fourth temporary variables to obtain a third substitution permutation variable.

7. The data processing method of claim 1, wherein performing data replication processing on the input parameter comprises:
performing data compression processing on the input parameter to obtain a compressed input parameter; and
performing data replication processing on the compressed input parameter.

8. The data processing method of claim 7, wherein performing data compression processing on the input parameter to obtain a compressed input parameter comprises:
in response to a number of bits of the input parameter being equal to a preset bit number, segmenting bytes in the input parameter to obtain a plurality of parameters to be processed; and
performing exclusive OR processing on the plurality of parameters to be processed to obtain the compressed input parameter.

9. The data processing method of claim 7, wherein performing data compression processing on the input parameter to obtain a compressed input parameter comprises:
in response to a number of bits of the input parameter being less than a preset bit number, performing data padding processing on the input parameter to obtain a padded input parameter;
segmenting bytes in the padded input parameter to obtain a plurality of parameters to be processed; and
performing exclusive OR processing on the plurality of parameters to be processed to obtain the compressed input parameter.

10. The data processing method of claim 1, wherein performing data integration processing on the plurality of output variables to obtain the index value comprises:
performing exclusive OR processing on the plurality of output variables to obtain an output parameter; and
performing data truncation processing according to the output parameter to obtain the index value.

11. A forwarding chip, comprising a memory, a processor, and a computer program stored in the memory and executable by the processor, wherein the computer program, when executed by the processor, causes the processor to perform a data processing method comprising:
acquiring an input parameter used for generating an index value to be filled in a hash table;
performing data replication processing on the input parameter to obtain a plurality of input parameters;
performing corresponding data mapping processing on each of the input parameters to obtain a plurality of output variables; and
performing data integration processing on the plurality of output variables to obtain the index value.

12. A non-transitory computer-readable storage medium, storing computer-executable instructions, wherein the computer-executable instructions are configured for implementing a data processing method comprising:
acquiring an input parameter used for generating an index value to be filled in a hash table;
performing data replication processing on the input parameter to obtain a plurality of input parameters;
performing corresponding data mapping processing on each of the input parameters to obtain a plurality of output variables; and
performing data integration processing on the plurality of output variables to obtain the index value.

13. A computer program product, comprising a computer program or computer instructions stored in a computer-readable storage medium, wherein the computer program or the computer instructions, when read from the computer-readable storage medium and executed by a processor of a computer device, causes the computer device to perform the data processing method of claim 1.

14. The data processing method of claim 3, wherein the S-box processing comprises:
performing splitting processing on the input parameter to obtain a plurality of first temporary variables;
obtaining a plurality of second temporary variables according to the plurality of first temporary variables and a preset substitution table; and
performing integration processing on the plurality of second temporary variables to obtain a first substitution permutation variable.

15. The data processing method of claim 3, wherein the bit permutation processing comprises:
obtaining a target position corresponding to each bit in the first substitution permutation variable according to a preset bit permutation table and a value of the bit; and
performing position adjustment processing for each bit in the first substitution permutation variable according to the target position to obtain a second substitution permutation variable.

16. The data processing method of claim 3, wherein the matrix multiplication processing comprises:
segmenting bits in the second substitution permutation variable to obtain a plurality of third temporary variables having a first data length;
performing bitwise exclusive OR processing between each of the third temporary variables and each row of matrix elements in a preset matrix to obtain a plurality of fourth temporary variables, wherein a length of each row of elements and a length of each column of elements in the preset matrix are equal to the first data length; and
performing integration processing on the plurality of fourth temporary variables to obtain a third substitution permutation variable.

17. The data processing method of claim 8, wherein the segmentation of the bytes in the input parameter is an equal segmentation.

18. The data processing method of claim 9, wherein performing data padding processing on the input parameter comprises padding higher bits in the input parameter with zeros such that the number of bits in the input parameter is equal to the preset bit number.

19. The data processing method of claim 9, wherein the segmentation of the bytes in the input parameter is an equal segmentation.

20. The data processing method of claim 1, wherein the output parameters and the index value are presented in a binary form, an octal form, a decimal form, or a hexadecimal form.
